(19) United States
(12) Patent Application Publication
(10) Pub. No.: US 2004/0111590 A1
(43) Pub. Date: Jun. 10, 2004

(54) Self-configuring processing element

(76) Inventor: Robert C. Klein JR., Macungie, PA (US)

Correspondence Address: Pepper Hamilton LLP, 50th Floor, One Mellon Center, 500 Grant Street, Pittsburgh, PA, 15219, US

(21) Appl. No.: 10/625,186

(22) Filed: Jul. 23, 2003

Related U.S. Application Data
(60) Provisional application No. 60/398,149, filed on Jul. 23, 2002.

(51) Int. Cl. G06F 9/00

(52) U.S. Cl. 712/226

(57) ABSTRACT

A self-configuring processing element for providing arbitrarily wide, application-specific instruction set extensions to an Instruction Set Architecture (ISA) microcontroller includes a System Bus Interface and Instruction Handler (SBI), an Input Router and Conditioner (IRC), an ALU, a Memory, and an Output Router. The SBI may accept address, data and control signals and may include a unique address decoder, an instruction register that decodes address and data bits, a state machine for sequencing through initialization and instruction set-up, and transceivers for controlling data flow with the system bus and feedback. The IRC may select information to transmit to the ALU and/or the Memory and may include circuitry for registering, shifting, incrementing, and decrementing inputted information. The ALU and the Memory may perform operations on the output of the IRC. The Output Router may route the output of the ALU and/or the Memory to one or more possible destinations.

### CLAIM OF PRIORITY

This application claims priority to, and incorporates by reference in its entirety, the U.S. provisional patent application No. 60/398,149, filed Jul. 23, 2002.

### FIELD OF THE INVENTION

The present invention relates generally to a configurable processing block and, more specifically, to a self-configuring processing element for providing arbitrarily wide application-specific instruction set extensions to a standard Instruction Set Architecture microcontroller in a semiconductor device.

### BACKGROUND OF THE INVENTION

Various forms of configurable processing elements have been implemented in Field Programmable Gate Arrays (FPGAs) and Complex Programmable Logic Devices (CPLDs). In traditional FPGA and CPLD architectures, configurable processing elements include Look-Up Table (LUT)-based and/or multiplexer-controlled logic elements.

One problem with devices using conventional configurable processing elements is configuration latency. In such devices, every aspect of the device is programmed after the chip is powered on, including every logical function and every connection point for a given application. Each of these functions and connection points must be set by values contained in a configuration bit stream. As the size of the configuration bit stream increases, the delay in loading the configuration bit stream increases. Since the configuration bit stream is typically loaded serially, the configuration latency is directly proportional to the size of the configuration file.

Another problem that results from an increase in the size of the configuration bit stream is that the cost of a solution using devices with conventional configuration processing elements increases. As the number of functions and connection points increases, larger configuration files are required. Larger configuration files require larger external memories in which to store the files. Thus, as the size of the configuration bit stream increases, the size and cost of the external memory storing the configuration bits increases as well.

Yet another problem with devices using conventional configurable processing elements is that the entire device must be configured, or reconfigured, in one process. Conventional configurable processing elements are not capable of performing either a partial reconfiguration or a pipelined reconfiguration in typical operation.

While devices using conventional configurable processing elements maybe suitable for the particular purpose to which they were designed, they are not suitable for providing arbitrarily wide, application-specific instruction-set extensions to a standard Instruction Set Architecture (ISA) microcontroller.

### SUMMARY OF THE INVENTION

In view of the foregoing disadvantages inherent in the known types of configurable processing elements, the self-configuring processing element according to the present invention substantially departs from the conventional concepts and designs of the prior art. In so doing, the self-configuring processing element provides an apparatus developed to solve one or more of the problems described above. For example, a preferred embodiment of the self-configuring processing element may provide arbitrarily wide, application-specific instruction set extensions to a standard ISA microcontroller in a semiconductor device.

The general purpose of the present invention, which will be described subsequently in greater detail, is to provide a new self-configuring processing element that has many of the advantages of conventional configurable processing elements and novel features that result in a new self-configuring processing element.

In a preferred embodiment of the present invention, a processing element includes a system bus interface, an instruction handler, an input router and conditioner electrically connected to the system bus interface and the instruction handler, an ALU electrically connected to the input router and conditioner, a memory electrically connected to the input router and conditioner, and an output router electrically connected to the ALU, the memory and the input router and conditioner.

In an embodiment, the system bus interface and instruction handler include a connection to a system bus having a plurality of address lines and a plurality of data lines, an address decoder, connected to one or more of the plurality of address lines, for determining whether the processing element is selected by comparing a value contained on the one or more address lines with a decoding value and asserting an enable flag when the processing element is selected, an instruction register, connected to one or more of the plurality of address lines and one or more of the plurality of data lines, for storing the values contained on the one or more address lines and the one or more data lines when the enable flag is asserted, and a state machine, connected to the instruction register, for configuring the processing element based on at least one of the stored address value and the stored data value.

In an embodiment, the input router and conditioner include a first input path connected to an output of a first input processing element, a second input path connected to an output of a second input processing element, a third input path connected to an output of a third input processing element, one or more multiplexers for determining a data value, an address/data value, and a carry bit, and circuitry for selectively performing one or more operations on at least one of the data value and the address/data value and the carry bit. In an embodiment, the input router and conditioner further includes a fourth input path connected to a feedback path and/or a system bus.

In an embodiment, the one or more operations include performing a bit shift operation on at least one of the data value and the address/data value, incrementing at least one of the data value and the address/data value, decrementing at least one of the data value and the address/data value, storing at least one of the data value and the address/data value, and passing through at least one of the data value and the address/data value.

The one or more multiplexers may include a first multiplexer for determining a first portion of the data value, a second multiplexer for determining a second portion of the data value, a third multiplexer for determining a first portion of the address/data value, a fourth multiplexer for determining a second portion of the address/data value, and a fifth multiplexer for determining the carry bit. The first portion of the data value and the second portion of the data value may be of equal width. The first portion of the address/data value and the second portion of the address/data value may be of equal width.

In an embodiment, the first input processing element is located along an x-axis with reference to the processing element, the second input processing element is located along a y-axis with reference to the processing element, and the third input processing element is located in a diagonal direction with reference to the processing element.

In an embodiment, the output routing block includes a first output path connected to an input of a first output processing element, a second output path connected to an input of a second output processing element, and a third output path connected to an input of a third output processing element. The output router may further include a fourth output path connected to a feedback path and/or a data bus. In an embodiment, the first output processing element is located along an x-axis with reference to the processing element, the second output processing element is located along a y-axis with reference to the processing element, and the third output processing element is located in a diagonal direction with reference to the processing element.

In a preferred embodiment, a method of configuring a processing element includes providing an address value and a data value to the processing element, decoding the address value, determining from the decoded address value whether the processing element is selected, if the processing element is selected, storing at least a portion of the address value and the data value, loading the stored address value and the stored data value into a state machine associated with the processing element, and configuring, by the state machine, the processing element based on the stored address value and the stored data value. The configuring step may include enabling one or more components of the processing element, and determining the routing or one or more multiplexers within the processing element. The configuring step may further include storing one or more values, determined by at least one of the stored address value and the stored data value, in a memory.

In an alternate embodiment, a method of configuring a processing element includes providing an address value to the processing element, decoding the address value, determining from the decoded address value whether the processing element is selected, if the processing element is selected, storing at least a portion of the address value, loading the stored address value into a state machine, and configuring, by the state machine, the processing element based on the stored address value.

In an alternate embodiment, a processing element includes an input block and an output block. The input block includes a first input path connected to an output of a first input processing element, a second input path connected to an output of a second input processing element, a third input path connected to an output of a third input processing element. The output block includes a first output path connected to an input of a first output processing element, a second output path connected to an input of a second output processing element, and a third output path connected to an input of a third output processing element. In an embodiment, the input block further includes a fourth input path connected to a feedback path and/or a system bus. In an embodiment, the first input processing element is located along an x-axis with reference to the processing element, the second input processing element is located along a y-axis with reference to the processing element, and the third input processing element is located in a diagonal direction with reference to the processing element. In an embodiment, the output block further includes a fourth output path connected to a feedback path and/or a system bus. In an embodiment, the first output processing element is located along an x-axis with reference to the processing element, the second output processing element is located along a y-axis with reference to the processing element, and the third output processing element is located in a diagonal direction with reference to the processing element.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the terminology used herein is for the purpose of the description and should not be regarded as limiting.

### BRIEF DESCRIPTION OF THE DRAWING

Various other objects, features and attendant advantages of the present invention will become fully appreciated as the same becomes better understood when considered in conjunction with the accompanying drawings, in which like reference numbers designate the same or similar parts throughout the following text.

FIG. 1 depicts an exemplary embodiment of a self-configuring processing element according to an embodiment of the present invention.

FIG. 2 is a flowchart illustrating exemplary steps in a method of configuring the processing element.

FIG. 3 depicts an exemplary use of a group of self-configuring processing elements in a two-dimensional toroidal interconnect structure.

### DETAILED DESCRIPTION OF THE INVENTION

Before the present methods are described, it is to be understood that this invention is not limited to the particular methodologies or protocols described, as these may vary. It is also to be understood that the terminology used in the description is for the purpose of describing the particular versions or embodiments only, and is not intended to limit the scope of the present invention which will be limited only by the appended claims. In particular, although the present invention is described in conjunction with a silicon-based electrical circuit, it will be appreciated that the present invention may find use in any electrical circuit design.

It must also be noted that as used herein and in the appended claims, the singular forms “a”, “an”, and “the” include plural references unless the context clearly dictates otherwise. Thus, for example, reference to a “processing element” is a reference to one or more processing elements and equivalents thereof known to those skilled in the art, and so forth. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications mentioned herein are incorporated by reference. Nothing herein is to be construed as an admission that the invention is not entitled to antedate such disclosure by virtue of prior invention.

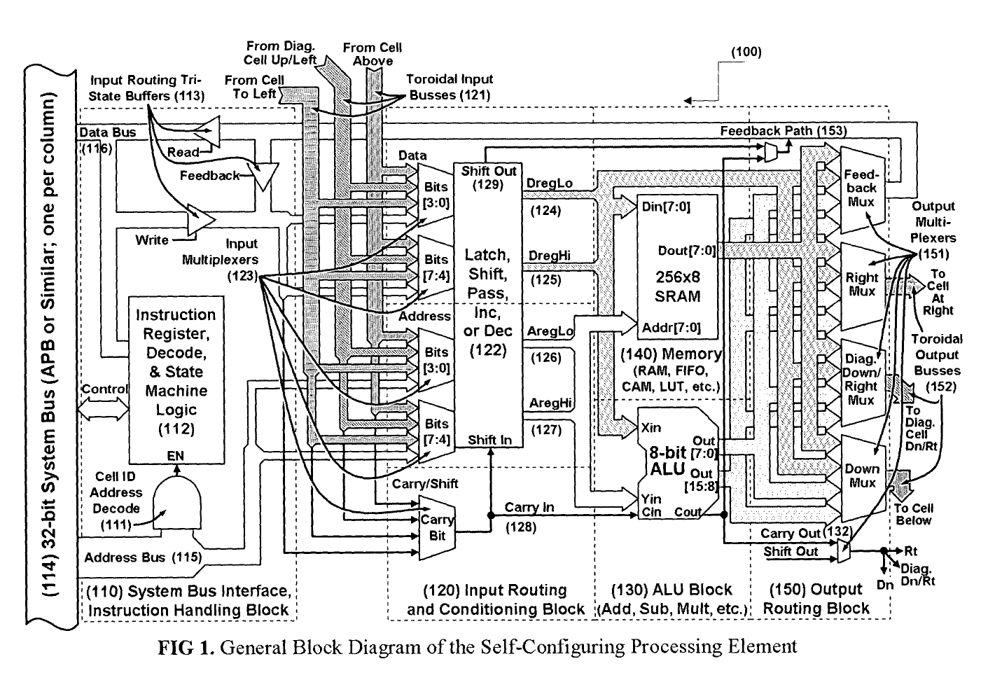

Turning now descriptively to the drawings, FIG. 1 illustrates a self-configuring processing element 100, which may include the System Bus Interface and Instruction Handling (SBI) block 110, the Input Routing and Conditioning (IRC) block 120, the Arithmetic Logic Unit (ALU) block 130, the Memory block 140, and/or the Output Routing block 150.

The SBI block 110 accepts address, data, and control information from one or more microcontrollers, microprocessors, digital signal processors and/or state machines via a system bus 114. The one or more microcontrollers, microprocessors, digital signal processors, and/or state machines may reside in the same electrical circuit as the processing element 100, or it may be external to the electrical circuit. Although FIG. 1 illustrates a 32-bit system bus, system busses of other sizes may be used. The SBI block 110 may include a cell ID address decoder 111, a register for holding appropriate bits from the system address bus 115 and system data bus 116, a state machine for sequencing through processing element initialization and instruction set-up tasks, and/or tri-state buffers 113 for controlling data flow to and from the system bus 114 and/or for feedback within the processing element 100. The above-described register and state machine are collectively represented by block 112 in FIG. 1.

A specific range of binary addresses may be assigned to each processing element integrated into a system. The cell ID address decoder 111 of the SBI block 110 may respond to a specific range of addresses in the address field of the system bus 114 that are defined for the particular instance in which the cell ID address decoder 111 is located. If the information present on the system bus 114 falls within the range, the cell ID address decoder 111 may enable the Instruction Register, Decode, and State Machine logic block 112 via an enable signal. The Instruction Register, Decode, and State Machine logic block 112 may respond by decoding the information from the address bus 115 and the data bus 116 in order to perform one or more of several actions. These actions may include, but are not limited to, the following:

1. WRITEMEM: This function may write data from the data bus 116 to a given location in the Memory block 140. The address of the location to be modified may be determined by information from the address bus 115. This command maybe used to create a full-custom instruction by specifying the contents of the Memory block 140 for Look-Up Table (LUT) logical functions.

2. READMEM: This function may drive the contents of the Memory block 140 onto the system bus. The address of the location to be read may be determined by information from the address bus 115.

3. READALU: This function may drive the contents of the ALU block 130 onto the data bus 116.

4. READBUS: This function may drive a copy of one of the input busses 121 or output busses 152 onto the data bus 116. The source bus (i.e., whether an input 121 or output bus 152 is read) may be determined by information from the address bus 115.

5. WRITEBUS: This function may drive one of the input busses 121 or output busses 152 with the data on the data bus 116. The destination bus may be determined by information from the address bus 115 which may drive the select lines of the Output Multiplexers 151.

6. WRITEINST: This function may initialize the state machine 112 in the SBI block 110. The addressed processing element 100 may perform a series of actions controlled by the state machine 112 that result in the processing element 100 being configured to perform one of a predetermined set of instructions. Information on the address bus 115 may determine which instruction is used to configure the processing element 100. The predetermined set of instructions may be further refined by the contents of the data bus 116. For example, a command may be issued to instruct the processing element 100 to create a “Multiply by $7E” instruction (a hexadecimal multiply-by-a-constant function). The selection of the “multiply-by-a-constant” configuration may be encoded in the address bus 115, while the “$7E” (i.e., the specific constant to multiply by) may be read from the data bus 116.

7. SELECTIN: This function may determine one or more sources for subsequent input data 124-127 and carry-in 128 signals for the processing element 100. The one or more sources may be determined by information in the address or data fields of the system bus 114. The routing may be performed by the Input Multiplexers 123.

8. SELECTOUT: This function may determine one or more destinations for subsequent output data 152 and 153 and the carry-out signal 132 for the processing element 100. The one or more destinations may be determined by information in the address or data fields of the system bus 114.

9. SELECTMEM: This function may configure the processing element 100 and its associated Memory block 140 to be one of a pre-determined set of memory functions.

These memory functions may include, but are not limited to, Static Random Access Memory (SRAM), First-In-First-Out (FIFO), Last-In-First-Out (LIFO), Content Addressable Memory (CAM), or a shift register. The selection of the function for the Memory block 140 may be made based on information in the address or data fields of the system bus 114.

The SBI block 110 is not limited to the construction set forth above. Variations on this block may include, but are not limited to, alternate system bus interface architectures resulting from different system busses being used, including a system bus where information is passed over shared connections such as the Toroidal Input Busses 121, alternate methods of decoding and using the information from the data bus 116, the address bus 115 and control signals, different bus word widths and data word widths, and support for modified or different instructions by the state machine 112. The microcontrollers, microprocessors, digital signal processors and/or state machines controlling the system bus may be either on-chip or off-chip. The instructions and data may also be supplied by other processing elements connected, either directly or indirectly, to the self-configuring processing element 100.

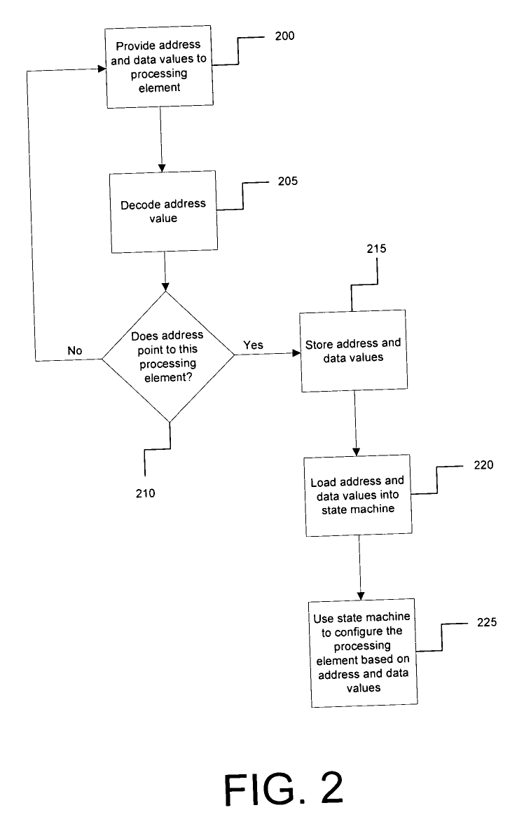

FIG. 2 is a flowchart illustrating exemplary steps in a method of configuring the processing element 100. First, an address value and/or a data value may be provided 200 to the processing element 100. The address value may be decoded 205, and a determination may be made 210 from the decoded address value as to whether the processing element is selected. If the processing element 100 is selected, at least a portion of the address value and/or the data value may be stored 215. The stored address value and/or the stored data value may be loaded 220 into a state machine associated with the processing element 100. The state machine may configure 225 the processing element 100 based on the stored address value and/or the stored data value. This configuration may include, but is not limited to, setting enable flags and multiplexer selects, defining memory locations in the Memory block 140, and determining the function to perform in the ALU 130.

Returning to FIG. 1, the Input Routing and Conditioning block 120 may select and connect the available inputs to the ALU block 130 and the Memory block 140 via Input Multiplexers 123. In addition, the IRC block 120 may include circuitry for registering, shifting, incrementing, and/or decrementing the inputs received or loaded. Such circuitry is collectively represented by block 122 of FIG. 1. The configuration of the Input Multiplexers 123 and the specific action to be performed on the incoming data may be determined by information in the Instruction Register, Decode and State Machine logic block 112 in the SBI block 110.

A method of processing an exemplary instruction will now be described in order to show the operation of the IRC block 120. The SBI block 110 may receive information from the address bus 115 requesting that the processing element 100 implement a “multiply by a constant” function. The State Machine 112 in the SBI block 110 may load the constant to be multiplied from the data bus 116 into a register in the circuitry of block 122 that has an output sent to one input to the ALU block 130. The ALU 130 may be set to accumulation mode (add-to-output) by the SBI block 110. The incrementor in the circuitry of block 122 may then, starting from zero, supply address information to the memory, which may be SRAM or other appropriate memory, in the Memory block 140. The State Machine 112 in the SBI block 110 may then cycle through one state for each location in the Memory block 140. In a preferred embodiment, 256 memory locations are used, and the State Machine 112 may cycle through 256 states. In each state, the value stored in the register in the IRC block 120 may be added to the output of the ALU 130, the counter in the circuitry of block 122, which is connected to the address inputs of the Memory 140, may increment, and the selected location in Memory 140 may be written with the accumulated data from the output of the ALU 130. When this process is completed and the instruction is executed, the Memory 140 may respond by outputting a result equal to the constant multiplied by a value on the address lines of the Memory 140.

In a preferred embodiment, this function may be initialized by a single command received from the system bus 114. Once the command is issued, the initialization procedure may proceed without the intervention or control of the system bus 114 or any external device. The lack of the need for direct control over the initialization procedure may allow the system bus 114 to be used to perform other tasks instead of monitoring particular processing elements or waiting for the initialization procedure to complete. In this manner, the configuration latency inherent in devices using conventional configurable processing elements may be reduced in devices incorporating the present invention. Of course, systems using control by the system bus 114, although not required, may be included in the scope of the present invention.

The connections between the IRC block 120 and the ALU/Memory block 130 will now be described. In a preferred embodiment, as shown in FIG. 1, there may be, for example, four separate busses that are used to form the data and address inputs to the Memory 140. Each bus may also be used to form the X and Y inputs of the ALU 130. Each bus, in a preferred embodiment, may be four bits wide. Alternate widths may be selected for each bus individually without limitation. In addition, a carry-in signal may be passed to the ALU 130. The carry-in signal may also be used as the input to the least significant bit of the shifter/counter circuitry 122 in the IRC block 120. The shift out signal of the most significant bit of the shifter/counter circuitry 122 may be an additional single-bit output that is presented to the Output Routing block 150 for direction to its ultimate destination (if any).

Variations on these signals may include altering the width of the input busses 121 and/or selection circuitry 122, changing the method of encoding, decoding and routing the input busses 121 to the outputs of the circuitry 122, and modifying the logical structure of the internal shifter/counter circuitry 122. Each of these modifications will be apparent to one of skill in the art and are considered to be within the scope of this invention.

The ALU block 130 may receive inputs 124-127 from the IRC block 120 and perform operations on such inputs 124-127 based on the information in the Instruction Register, Decode and State Machine logic 112 in the SBI block 110. The ALU block 130 may include an eight-bit ALU (with 16 outputs to account for overflow and accumulation). The IRC block 120 may determine the sources for the various inputs 124-127 to the ALU 130. Variations on the ALU block 130 may include, without limitation, ALUs of different widths, different input bus widths, variations in the functions performed by the ALU, and/or the potential sources and destinations of data operated on by the ALU. Each of these modifications, including designing ALUs and the functions performed by ALUs, will be apparent to one of skill in the art and are considered to be within the scope of this invention.

The Memory block may receive inputs 124-127 from the IRC block 120 and perform operations on such inputs 124-127 based on the information in the Instruction Register, Decode and State Machine logic 112 in the SBI block 110. The Memory block 140 may include a memory. In a preferred embodiment, the Memory block 140 may include a dual-port 256×8 SRAM cell (with separate read and write data ports, but a common address port). Additional logic in the IRC block 120 may be used to make the memory element operate as, for example, a FIFO, LIFO, CAM, or LUT. In the LUT mode, any logical function of eight inputs maybe realized in the memory element. After a desired function is loaded into the memory, as determined by a microcontroller and received by the SBI block 110 via a system bus, the data for performing the function may be supplied by the IRC block 120 to the memory. Based on the information stored in the memory, any logical function may be performed. Alternate memories including, without limitation, DRAMs, FLASH, and EEPROMs maybe used instead of SRAM. In addition, the memory may be of different size and may have a different read/write port configuration.

The Output Routing block 150 may receive data from the outputs of the ALU block 130 and the Memory block 140 and route the data to one or more of a plurality of destinations. The specific destinations to be selected may be determined by information in the Instruction Register, Decode and State Machine logic 112 in the SBI block 110. In a preferred embodiment, the Output Routing block 150 may include, for example, four byte-wide (eight-bit) four-to-one multiplexers 151 that select sources for three output busses 152 and one feedback bus 153. A separate two-to-one multiplexer 151 may be provided to determine whether the most significant bit 129 of the shifter/counter circuitry 122 of the IRC block 120 or the carry out bit 132 from the ALU block 130 is used as a source for the three output busses 152 and the feedback bus 153. The SBI block 110 may select the source passed through each multiplexer 151 based on the decoded instruction received from the system bus 114. Details of the connections to and from the Output Routing block 150 will be set forth later in this document.

Variations in the Output Routing block 150 may include changes to the quantity and word widths of the inputs and outputs 152 and 153, the decoding of the potential sources and destinations 152 and 153, or the granularity of control (i.e., the number of bits that may be selected from each source and combined and sent to a given destination). Each of these modifications will be apparent to one of skill in the art and are considered to be within the scope of this invention.

In a preferred embodiment, a number of different types of connections may be present with respect to a processing element 100. These connections may include connections via the system bus 114 to other system resources, such as one or more microcontrollers, microprocessors, digital signal processors, state machines, input/output pins, communication ports, and/or bulk memory blocks, connections from one processing element 100 to other processing elements, and connections within an individual self-configuring processing element 100.

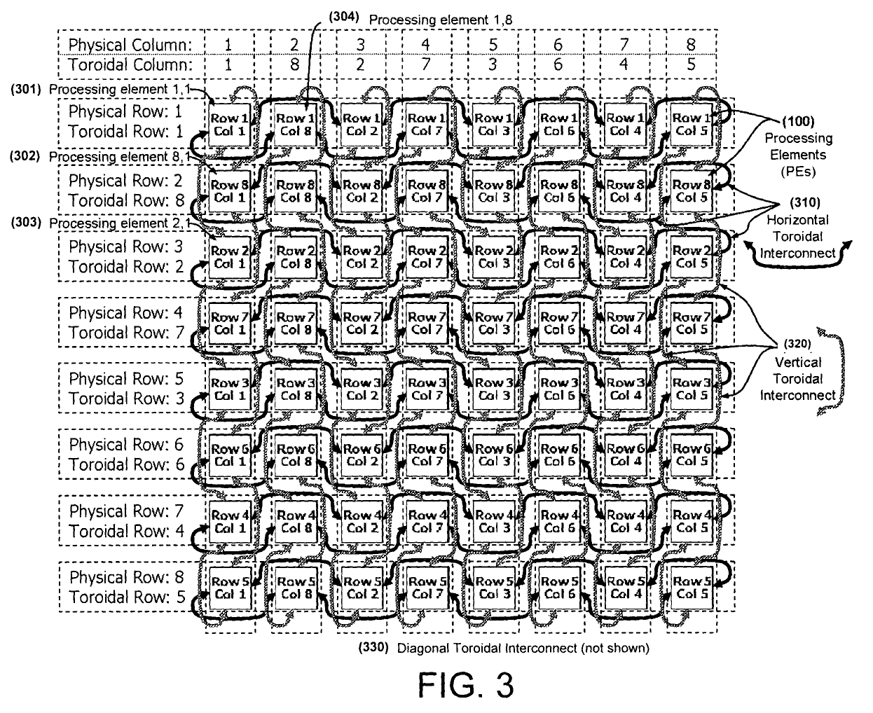

Referring to FIG. 1, the system bus 114 may allow information and data to be sent to and from the self-configuring processing element 100. The system bus 114 maybe connected to onchip and/or external functional blocks including, without limitation, one or more microcontrollers, microprocessors, digital signal processors, state machines, input/output pins, communication ports, and/or memory blocks. The system bus 114 may enable data, control, configuration and status information to be passed into and out of a logic fabric created by an array of processing elements, such as that illustrated in FIG. 3. The system bus 114 may be any microprocessor bus architecture used by those skilled in the art. Such busses are commonplace in CPUs, embedded microcontrollers, digital signal processors, and most application-specific integrated circuits (ASICs). The system bus 114 may contain address, data and control signals. The address signals may be used to determine the devices and/or locations on the system bus 114 that have been selected to transmit or receive data in a given system cycle. Data signals may be used to transfer information over the system bus 114. Control lines may include such signals as read/write, clock, reset, and enables that may be used for supervisory and/or timing purposes.

The many potential sources and destinations for the signals on the system bus 114 may require long, physically robust connections and additional buffering and/or drivers for the most heavily loaded signals. Since all logical and electrical functional blocks attached to the system bus 114 share these connections, a supervising program, processor or state machine may be used to determine which blocks send and receive data and in which order. To this end, a supervising program, processor or state machine may arbitrate simultaneous requests for the use of resources in order to avoid conflicts or bus contention.

In a preferred embodiment, the system bus 114 uses the ARM Microprocessor Bus Architecture (AMBA) as specified in the ARM AMBA manual (Doc No.: ARM IHI-0011, Issued: May 1999 by ARM Holdings plc, 90 Fulboum Road, Cambridge CB1 9NJ, UK). This document describes an AHB (Advanced High-Performance Bus) and an APB (Advanced Peripheral Bus) that together comprise the system bus 114. Only the APB attaches directly to a processing element 100. A unique APB is used for each column of processing elements in a device. The columnar APB is addressed and activated by address information sent over the AHB. Information, such as configuration data and status information, and data may be passed between a microcontroller and the processing elements through this bus structure. The separation of control, implemented in the system bus 114, and datapath, implemented in the interconnection of processing elements, permits a more efficient use of resources within devices incorporating one or more processing elements 100 according to the present invention.

In a preferred embodiment, each self-configuring processing element 100 may be connected to the system bus 114 through a columnar APB. All processing elements within a column may share the address, data and control signals of the APB 114 associated with that column. The address signals of the APB 114 maybe used to select one or more processing elements as the source or destination for the information carried in the data and control signals of the APB. In addition, the address lines may determine which data, configuration bits or memory locations within the one or more processing elements 100 are accessed.

Each individual columnar APB may be selectively connected to the AHB by decoding the address signals of the AHB. The columnar APBs may also serve as the connections to other system resources such as bulk memory blocks, input/output pins, and serial communication modules. Any configuration information needed by these other resources may also be sent and read-back across the columnar APBs.

With respect to the connections between processing elements, the preferred interconnection structure may be toroidal in nature, as described in a co-pending U.S. patent application entitled “Improved Interconnect Structure for Electrical Devices,” filed Jul. 23, 2003 with Ser. No. (not yet assigned), which is incorporated herein by reference in its entirety. The toroidal interconnect structure 300 may include, for example, three potential datapath sources 121 and, for example, three potential destinations 152 for each processing element 100. These sources and destinations may include other processing elements 100. Additional sources and destinations may include the system bus 114 and a feedback path 153 within a processing element 100.

As shown in FIG. 3, the toroidal interconnect structure 300 may have x-direction (referred to herein as “horizontal” or “row”) datapaths 310 and y-direction (referred to herein as “vertical” or “column”) datapaths 320. In addition, the toroidal interconnect structure 300 may have a diagonal, or effective “top left toward bottom right,” datapath 330 that is also toroidal in nature. Other potential structural and functional variations may include providing a similar toroidal interconnect along other diagonal paths, skipping multiple rows/columns, or simply creating the toroidal interconnect in fewer directions than is described herein (for example, a column-based, “vertical-only” toroidal interconnect.) Note that rows and/or columns are not necessarily skipped at edge elements, as an edge element may loop back to its nearest neighbor.

In FIG. 3, the terms “physical row” and “physical column” refer to the placement of a row or column, respectively, in a two-dimensional device layout. For example, the first physical row maybe the row of processing elements 100 that are physically located at the top of the physical media. Sequentially subsequent physical rows may be adjacent to and below preceding physical rows. Likewise, physical columns may be arranged from left to right, where the first physical column is the leftmost column in the physical device. Other embodiments and orientations are possible within the scope of the invention.

In FIG. 3, the terms “row in toroid” and “column in toroid” refer to the placement of a row or column, respectively, in the three-dimensional representation embodied in a two-dimensional device layout. For example, the first row in the toroid may be the row of processing elements 100 physically located at the top of the physical media. A sequentially subsequent row in the toroid may be physically at least two rows below the preceding row in the toroid until an edge of the two-dimensional device is reached. At this point, sequentially subsequent rows in the toroid may be the “skipped” rows in the device ordered from the bottom of the device to the top. Likewise, columns in a toroid may be ordered by starting from the leftmost row, selecting every other row until the edge of the physical device is reached, and then selecting the “skipped” rows from right to left. Other embodiments and orientations are possible within the scope of the invention.

In the toroidal interconnect structure 300, the potential inputs may be from a processing element along a y-axis (e.g., above), a processing element along an x-axis (e.g., to the left), and a processing element diagonally disposed (e.g., above and to the left) from the processing element 100. The data source for the processing element 100 may be selected from one or more of these potential source processing elements, the system bus 114, or a feedback path 153. The information from the selected data source 124-127 may be passed from the IRC block 120 into the ALU block 130 and the Memory block 140 via Input Multiplexers 123 and the shifter/counter circuitry 122 that may be controlled by the configuration of the processing element 100.

The terms “above” and “to the left of” may not designate the physical two-dimensional relationships between processing elements. Instead, these terms may designate the placement of a processing element 100 within a three-dimensional toroidal interconnect structure 300. In the physical device, the processing element 100 may be one or more rows or columns removed from the processing element which is “above” or “to the left of” the processing element 100.

In a preferred embodiment incorporating the three-dimensional toroidal interconnect structure 300, each processing element 100 may potentially output data to one or more of a processing element along a y-axis (e.g., below), a processing element along an x-axis (e.g., to the right), or a processing element diagonally disposed (e.g., below and to the right) from the processing element 100. The output destinations may also include the system bus 114 or the feedback path 153 within the processing element 100. The processing element 100 may drive one or more of these potential destinations 152 and 153 at the same time. The determination of which outputs 152 and 153 are driven by the Output Routing block 150 may be determined by the configuration of the processing element 100.

The terms “below” and “to the right of” may not designate the physical two-dimensional relationships between processing elements. Instead, these terms may designate the placement of a processing element 100 within a three-dimensional toroidal interconnect structure 300. In the physical device, the processing element 100 may be one or more rows or columns removed from the processing element which is “below” or “to the right of” the processing element 100.

With respect to the connections within a processing element 100, the following connections represent an exemplary embodiment of the present invention. Variations may be made with regard to the connection paths including, without limitation, the width of the connection path, the source of the connection path, and the destination of the connection path. Each of these modifications will be apparent to one of skill in the art and are considered to be within the scope of this invention.

In a preferred embodiment, the system bus 114 may attach to the SBI block 110. Address signals from the system bus 114 may be decoded by a cell ID address decoder 111 that may uniquely identify the address of the processing element 100. In an embodiment, a number of address signals, for example, eight, may be attached from the system bus 114 to the IRC block 120. These address signals 115 may be further grouped into sub-groups. In a preferred embodiment, each of two sub-groups may be four bits wide. These sub-groups may be individually selected by four-to-one Input Multiplexers 123 in the IRC block 120 that are controlled by the configuration contained in the SBI block 110 to determine the low-order (bits 3:0) and/or high-order (bits 7:4) inputs to the address inputs of the Memory 140 and/or the Y inputs of the ALU 130. For example, the low-order address signals may be selected from a Toroidal Input Bus 121 and the high-order inputs may be selected from the system bus 114.

In a preferred embodiment, if the processing element 100 recognizes its address on the system bus 114, a number of data signals 116, for example, eight, may be latched into the Instruction Register, Decode and State Machine logic 112 in the SBI block 110. The data signals 116 may also be passed to the IRC block 120. The data signals 116 may be further grouped into sub-groups. In an embodiment, each of two sub-groups may be four bits wide. These subgroups may be individually selected by four-to-one Input Multiplexers 123 in the IRC block 120 that are controlled by the configuration contained in the SBI block 110 to determine the low-order (bits 3:0) and/or high-order (bits 7:4) inputs to the data inputs of the memory and/or the X inputs of the ALU contained in the ALU/Memory block 130. For example, the low-order input may be selected from the feedback path 153 and the high-order input may be selected from a toroidal input bus 121.

In a preferred embodiment, the Output Routing block 150 may take the output from the Memory 140, the output from the ALU 130, and the output of the IRC block 120 as potential outputs to each of the processing element below (i.e., logically interconnected along a y-axis), the processing element to the right (i.e., logically interconnected along an x-axis) of and the processing element diagonally below and to the right of the processing element 100, the system bus 114, and the feedback path 153. Optionally and preferably, the feedback path 153 is connected to the data path 116. In a preferred embodiment, the output from the Memory 140 may be eight bits, the output from the ALU 130 may be sixteen bits, and the output of the IRC block 120 may be eight bits. These bit widths are exemplary only. Outputs of different size may be used within the scope of this invention. The selection of the bits to place on each output 152 and 153 may be performed via, for example, four eight-bit wide four-to-one Output Multiplexers 151 in the Output Routing block 150 and two banks of tri-state buffers 113 that are each eight bits in width (for the system bus 114 and feedback path 153 outputs). Preferably, a carry bit multiplexer 152 is also provided. The Output Multiplexers 152 preferably determine data value. The selection criteria may be decoded from the Instruction Register, Decode and State Machine logic 112 in the SBI block 110. In addition, a ninth bit may be sent to each of the three Toroidal Output Busses 152 and the feedback path 153 that contains either the carry-out 132 signal from the ALU 130 or the shift out signal 129 from the shifter/counter circuitry 122 in the IRC block 120. The section criteria for the ninth bit may also be decoded from the Instruction Register, Decode and State Machine logic 112 in the SBI block 110.

The Toroidal Input Busses 121 of a processing element 100 may, for example, be connected to the Toroidal Output Busses 152 of other processing elements. One method of connecting the processing elements is a toroidal interconnect structure 300 as shown in FIG. 3.

The connection paths internal to a processing element 100 described above represent only one method of interconnecting a self-configuring processing element 100. Those skilled in the art will recognize that other methods of interconnecting the blocks of a processing element are evident based on this disclosure. Potential variations include changes to the number, connectivity and/or bus-widths of the processing element 100 to the Toroidal Input Busses 121, the Toroidal Output Busses 152, the feedback path signals 153, and other internal busses. Changes to the bus widths may precipitate changes to the multiplexing structures of the IRC block 120 and the Output Routing block 150. Changing the width and/or depth of the Memory 140 and the ALU 130 may also require changes to the fundamental architecture of the interconnection paths. Each of these modifications will be apparent to one of skill in the art and are collectively considered to be within the scope of the invention.

With respect to the above description, it is to be realized that the optimum dimensional relationships for the parts of the invention, including variations in size, materials, shape, form, function and manner of operation, assembly and use, are readily apparent to one of skill in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operations shown and described, and accordingly, all suitable modifications and equivalents may be considered as falling within the scope of the present invention.

What is claimed is:

1. A processing element, comprising:
a system bus interface;
an instruction handler;
an input router and conditioner electrically connected to the system bus interface and the instruction handler;
an ALU electrically connected to the input router and conditioner;
a memory electrically connected to the input router and conditioner; and
an output router electrically connected to the ALU, the memory and the input router and conditioner.

2. The processing element of claim 1 wherein the system bus interface and instruction handler comprise:
a connection to a system bus, wherein the system bus comprises a plurality of address lines and a plurality of data lines;
an address decoder, electrically connected to one or more of the plurality of address lines, for determining whether the processing element is selected by comparing a value contained on the one or more address lines with a decoding value and asserting an enable flag when the processing element is selected;
an instruction register, electrically connected to one or more of the plurality of address lines and one or more of the plurality of data lines, for storing the values contained on the one or more address lines and the one or more data lines when the enable flag is asserted; and
a state machine, electrically connected to the instruction register, for configuring the processing element based on at least one of the stored address value and the stored data value.

3. The processing element of claim 1 wherein the input router and conditioner comprises:
a first input path electrically connected to an output of a first input processing element;
a second input path electrically connected to an output of a second input processing element;
a third input path electrically connected to an output of a third input processing element;
one or more multiplexers for determining a data value and an address/data value; and
circuitry for selectively performing one or more operations on at least one of the data value and the address/data value,
wherein the one or more operations include:
performing a bit shift operation on at least one of the data value and the address/data value,
incrementing at least one of the data value and the address/data value,
decrementing at least one of the data value and the address/data value,
storing at least one of the data value and the address/data value, and
passing through at least one of the data value and the address/data value.

4. The processing element of claim 3 wherein the input router and conditioner further comprises a fourth input path electrically connected to a feedback path.

5. The processing element of claim 3 wherein the input router and conditioner further comprises a fourth input path electrically connected to a system bus.

6. The processing element of claim 3 wherein the one or more multiplexers comprise:
a first multiplexer for determining a first portion of the data value;
a second multiplexer for determining a second portion of the data value;
a third multiplexer for determining a first portion of the address/data value; and
a fourth multiplexer for determining a second portion of the address/data value.

7. The processing element of claim 6 wherein the first portion of the data value and the second portion of the data value are of equal width.

8. The processing element of claim 6 wherein the first portion of the address/data value and the second portion of the address/data value are of equal width.

9. The processing element of claim 3 wherein the first input processing element is located along an x-axis with reference to the processing element, the second input processing element is located along a y-axis with reference to the processing element, and the third input processing element is located in a diagonal direction with reference to the processing element.

10. The processing element of claim 1 wherein the input router and conditioner comprises:
a first input path electrically connected to an output of a first input processing element;
a second input path electrically connected to an output of a second input processing element;
a third input path electrically connected to an output of a third input processing element;
one or more multiplexers for determining a data value, an address/data value, and a carry bit; and
circuitry for selectively performing one or more operations on at least one of the data value and the address/data value and the carry bit,
wherein the one or more operations include:
performing a bit shift operation on at least one of the data value and the address/data value,
incrementing at least one of the data value and the address/data value,
decrementing at least one of the data value and the address/data value,
storing at least one of the data value and the address/data value, and
passing through at least one of the data value and the address/data value.

11. The processing element of claim 10 wherein the one or more multiplexers comprise:
a first multiplexer for determining a first portion of the data value;
a second multiplexer for determining a second portion of the data value;
a third multiplexer for determining a first portion of the address/data value;
a fourth multiplexer for determining a second portion of the address/data value; and
a fifth multiplexer for determining the carry bit.

12. The processing element of claim 1 wherein the output router comprises:
a first output path electrically connected to an input of a first output processing element;
a second output path electrically connected to an input of a second output processing element; and
a third output path electrically connected to an input of a third output processing element.

13. The processing element of claim 12 wherein the output router further comprises a fourth output path electrically connected to a feedback path.

14. The processing element of claim 12 wherein the output router further comprises a fourth output path electrically connected to a system data bus.

15. The processing element of claim 12 wherein the first output processing element is located along an x-axis with reference to the processing element, the second output processing element is located along a y-axis with reference to the processing element, and the third output processing element is located in a diagonal direction with reference to the processing element.

16. A method of configuring a processing element comprising:
providing an address value and a data value to the processing element;
decoding the address value;
determining from the decoded address value whether the processing element is selected;
if the processing element is selected, storing at least a portion of the address value and the data value;
loading the stored address value and the stored data value into a state machine associated with the processing element, and
configuring, by the state machine, the processing element based on the stored address value and the stored data value.

17. The method of claim 16 wherein the configuring step comprises:
enabling one or more components of the processing element; and
determining the routing or one or more multiplexers within the processing element.

18. The method of claim 16 wherein the configuring step further comprises:
storing one or more values, determined by at least one of the stored address value and the stored data value, in a memory.

19. A method of configuring a processing element comprising:
providing an address value to the processing element;
decoding the address value;
determining from the decoded address value whether the processing element is selected;
if the processing element is selected, storing at least a portion of the address value;
loading the stored address value into a state machine, and
configuring, by the state machine, the processing element based on the stored address value.

20. A processing element, comprising:
an input block; and
an output block,
wherein the input block comprises:
a first input path electrically connected to an output of a first input processing element,
a second input path electrically connected to an output of a second input processing element,
a third input path electrically connected to an output of a third input processing element, and
wherein the output block comprises:
a first output path electrically connected to an input of a first output processing element,
a second output path electrically connected to an input of a second output processing element, and
a third output path electrically connected to an input of a third output processing element.

21. The processing element of claim 20 wherein the input block further comprises a fourth input path electrically connected to a feedback path.

22. The processing element of claim 20 wherein the input block further comprises a fourth input path electrically connected to a system bus.

23. The processing element of claim 20 wherein the first input processing element is located along an x-axis with reference to the processing element, the second input processing element is located along a y-axis with reference to the processing element, and the third input processing element is located in a diagonal direction with reference to the processing element.

24. The processing element of claim 20 wherein the output block further comprises a fourth output path electrically connected to a feedback path.

25. The processing element of claim 20 wherein the output block further comprises a fourth output path electrically connected to a system bus.

26. The processing element of claim 18 wherein the first output processing element is located along an x-axis with reference to the processing element, the second output processing element is located along a y-axis with reference to the processing element, and the third output processing element is located in a diagonal direction with reference to the processing element.
